(19) United States
(12) Patent Application Publication
(10) Pub. No.: US 2010/0066155 A1
(43) Pub. Date: Mar. 18, 2010

(54) Tire protection device attachment systems

(75) Inventors: Pascal Seradarian, Princeton Junction, NJ (US); Larry K. Rogers, Bordentown, NJ (US); Larry Stuck, Amherst, NY (US); Olivier Marsaly, L'Isle Adam (FR); Peter K. Hobe, Levittown, PA (US); James P. Koniers, Bensalem, PA (US); Olivier Noblanc, Philadelphia, PA (US); Matthew P. Sherman, Philadelphia, PA (US); Christopher R. Renson, Langhome, PA (US)

Correspondence Address: Steven R. Scott;Shlesinger & Fitzsimmons, 171 St. James Drive, Webster, NY, 14580, US

(73) Assignee: Hutchinson, SA

(21) Appl. No.: 12/456,250

(22) Filed: Jun. 12, 2009

Related U.S. Application Data
(60) Provisional application No. 61/131,977, filed on Jun. 13, 2008.

(51) Int. Cl. B60B 7/01; B60B 7/06

(52) U.S. Cl. 301/37.22; 301/37.102

(57) ABSTRACT

In this invention a tire protection attachment system utilizes adherent materials or mechanical attachments to the wheel rim to hold a covering of protective material adjacent the sidewall of a tubeless tire mounted on a circular wheel rim. The mechanical attachments are made to the outwardly flaring circumferential flange section adjacent the sidewall and/or to the transverse wall section of the wheel rim. Attachments to the flange section are characterized by the use of a clamping ring, a specially designed clip, and/or a circumferential retaining device with a variable circumference. The various embodiments described include embodiments where an intermediate body for use with a clamping ring is affixed to the flange, a clamping ring is bolted directly onto the flange section, a clamping ring is screwed onto the flange section (with the flange section and clamping ring being provided with interfacing circumferentially arranged screw threaded portions), and/or a clamping ring that is snapped onto the flange via interfacing circumferentially arranged interlocking portions on the ring and flange. Attachments to the transverse wall section are typically based on attachments to a stud fastening a two piece wheel together or a lug stud. A wheel cover can also be included and held in position via these same mechanical attachments. Finally, the embodiments are intended to avoid attachment via members inserted intermediate the flange and the bead. Thus, the preferred embodiments do not include such elements.

This application claims an invention which was disclosed in a provisional application filed Jun. 13, 2008; Ser. No. 61/131,977 entitled “TIRE PROTECTION DEVICE ATTACHMENT SYSTEMS” the said provisional application being incorporated herein by reference. The benefit under 35 USC 119(e) of the United States provisional application is hereby claimed, and the aforementioned application is hereby incorporated herein by reference.

### BACKGROUND AND SUMMARY

This invention pertains generally to systems for attachment of a tire protection device to a tire and/or wheel. A tire protection device generally takes the form of a covering applied to the exterior surface of a tire and is used to prevent or mitigate damage to the tire used in vehicle operation. The types of damage that tires are typically subjected to include, but are not limited to, cuts from rough terrain, sabotage, fire, and ballistic attacks. Various methodologies to attach the device to the tire and/or wheel are described herein. The geometry/design of the tire protection device(s) referenced herein and the materials/construction of the tire protection device(s) referenced herein are covered in separate filings, including those set forth in U.S. Provisional Application 61/073,897 and any successor application thereto—the teachings of which are incorporated herein by reference.

Methodologies for sidewall and tread protection have been covered in numerous U.S. patents. Representative examples of these patents include: U.S. Pat. No. 235,251 for “Sidewall Protector,” issued Mar. 6, 1915; U.S. Pat. No. 1,867,518 for “Mud Guard,” issued Apr. 10, 1928; U.S. Pat. No. 1,905,674 for “Splash Protector,” issued Jan. 2, 1931; U.S. Pat. No. 2,017,891 for “Skip Preventer,” issued Aug. 11, 1933; U.S. Pat. No. 2,334,388 for “Ornamental Sidewall,” issued Nov. 12, 1941; U.S. Pat. No. 3,187,797 for “Water Deflecting Sidewall,” issued Nov. 27, 1963; U.S. Pat. No. 3,811,488 for “Tread & Sidewall Protector,” issued Apr. 3, 1989; U.S. Pat. No. 4,030,530 for “Removable Tread,” issued Sep. 26, 1991; U.S. Pat. No. 4,111,250 for “Removable Tread,” issued Nov. 19, 1986; U.S. Pat. No. 4,235,271 for “Sidewall Protector,” issued Jul. 13, 1979; and U.S. Pat. No. 4,319,618 for “Sidewall Protector,” issued Apr. 28, 1980.

However, while all of the aforesaid prior devices and methods exist to protect certain aspects of the tire, all have disadvantages. First, the protection device(s) described that are compressed between the wheel flange and the tire bead may cause excessive wear on the tire bead. Second, the protection device(s) described with excessive or inaccessible hardware cannot be easily assembled or disassembled from the wheel/tire assembly. Third, in many cases, the protection device(s) described must be removed in order for the tire to be replaced.

The instant invention resolves and avoids these difficulties using novel attachment methodologies, resulting in numerous advantages. First, these methods for attachment of a protection device to a wheel/tire assembly are more versatile and robust. Second, these attachment methods for a protection device are simplified and require less time to assemble and disassemble. Third, these attachment methods for a protection device are simplified and require fewer parts to affix the device to the wheel/tire assembly. Fourth, these attachment methods can be used on any type of road wheel including, but not limited to, single and multi-piece wheels. Fifth, the mode of attachment for the protection device can include isolation methods that can prevent or mitigate damage to the wheel/tire assembly from impact or other dynamic shocks experienced during vehicle operation. Sixth, these attachment methods allow for lateral and radial tire and/or wheel flexing at various operating pressures. The numerous other advantages of our invention will become more apparent in view of the more detailed description and claims that follow.

### BRIEF DESCRIPTION OF THE DRAWINGS

FIG. 1 provides a perspective sectional view illustrating the protection device attached to the wheel/tire assembly by means of a clamping ring on the rim flange.

FIG. 2 provides a perspective sectional view illustrating the protection device affixed directly to the tire by means of spray on coatings or adhesives that apply directly to the tire and/or wheel.

FIG. 3 provides a more detailed perspective and cross-sectional schematic view illustrating the protection device attached directly to the rim using a threaded interface.

FIG. 4 provides a more detailed perspective and cross-sectional schematic view illustrating the protection device attached directly to the rim using a clip interface.

FIG. 5 provides a more detailed perspective and cross-sectional schematic detailed view of the clamping ring attached to the wheel/tire assembly using a threaded fastener.

FIG. 6 provides a more detailed perspective and cross-sectional schematic view illustrating the protection device attached to the wheel/tire assembly by means of a clamping ring on an intermediate body that is affixed to the wheel/tire assembly.

FIG. 7 provides a more detailed perspective and cross-sectional schematic view illustrating an alternative to welding or bonding a continuous supporting ring to the wheel/tire assembly.

FIG. 8 provides a more detailed perspective and cross-sectional schematic view illustrating the protection device attached to the wheel/tire assembly by means of a series of clips featuring slots with which the protection device mates.

FIG. 9 provides a more detailed perspective and cross-sectional schematic view illustrating the protection device attached to the wheel/tire assembly by means of circumferential clamping to the rim flange.

FIG. 10 provides a perspective sectional view illustrating the protection device attached to the wheel/tire assembly using the stud and/or nut that fastens a multi-piece wheel together.

FIG. 11 provides a more detailed perspective and cross-sectional schematic view illustrating attachment of the ring to the wheel hardware.

FIG. 12 provides a perspective sectional view illustrating the protection device attached to the wheel/tire assembly in the disc area using the lug stud and/or lug nut that fastens the wheel assembly to the vehicle hub.

FIG. 13 provides a more detailed perspective and cross-sectional schematic view illustrating attachment to the wheel hardware using a bracket or other type of standoff.

FIG. 14 provides a perspective sectional view illustrating the protection device combined with the functionality of a wheel cover.

FIG. 15 provides a more detailed perspective and cross-sectional schematic view illustrating the principles of FIG. 14.

FIG. 16 provides a perspective sectional schematic view illustrating attachment to the wheel hardware using a circumferential adapter ring and additional hardware.

### DESCRIPTION

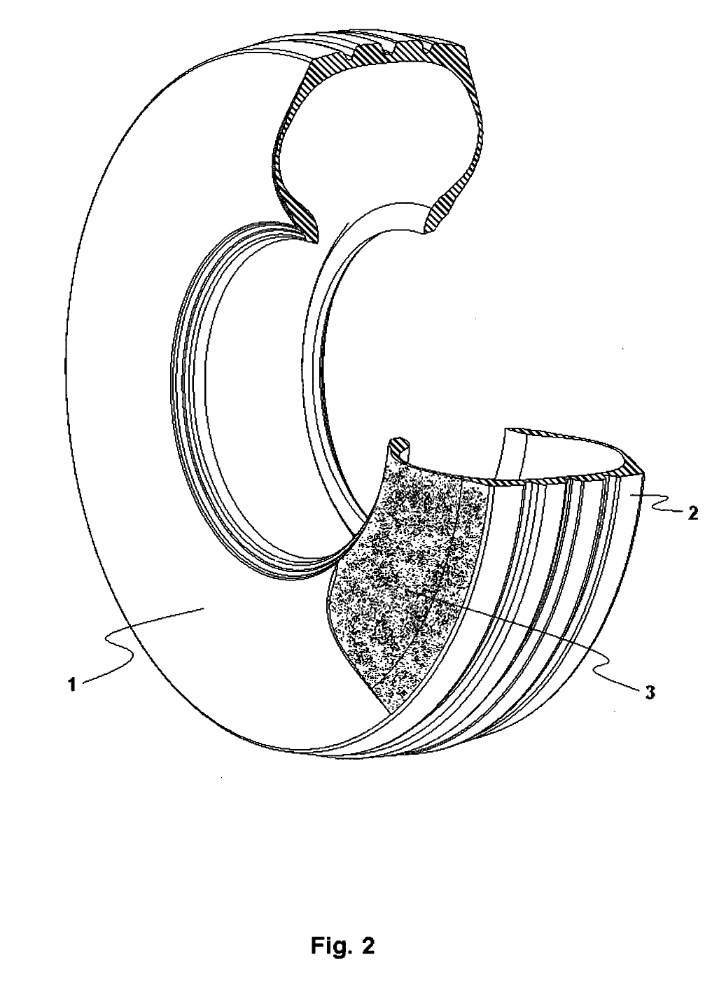

FIG. 2 illustrates the protection device 1 affixed directly to the tire 2 by means of spray on coatings or adhesives 3 that apply directly to the tire and/or wheel. (Although steel wheels are shown in many of the drawing figures, it is clear that many of these concepts can be extended to wheels constructed of any material or combinations of material. Also, most of the concepts described can be applied to one-piece or multi-piece rims).

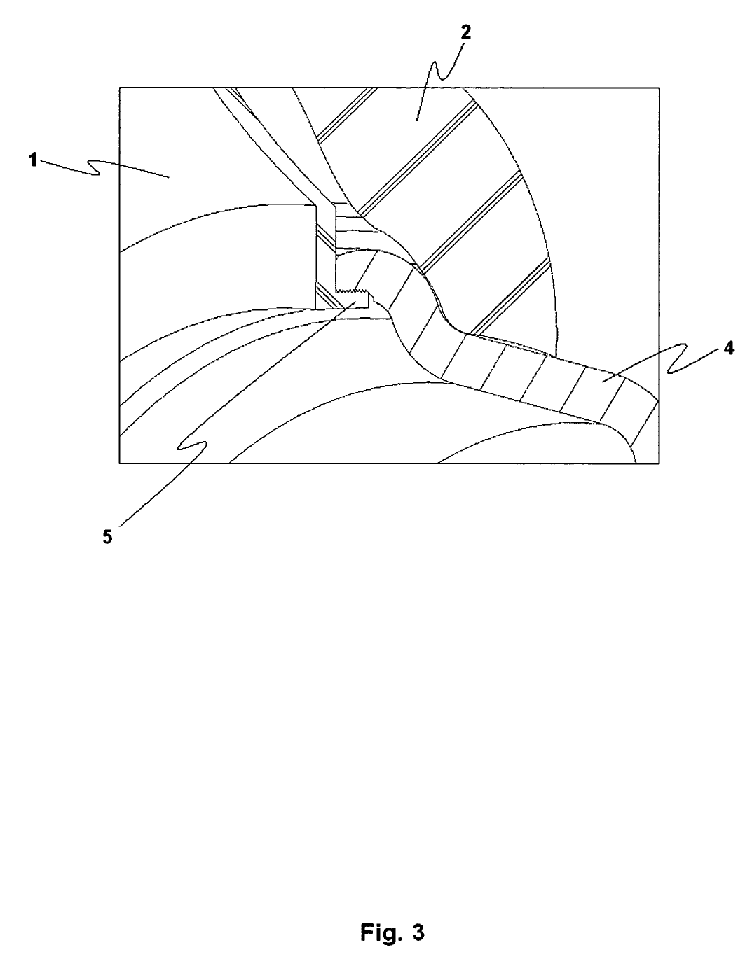

FIG. 3 illustrates the protection device 1 attached directly to the rim 4 using a threaded interface 5. The protection device 1 is constructed with external threads that interface with internal threads on the wheel itself. The protection device 1 revolves onto the wheel, which results in the threads engaging one another. The connection is maintained through the use of a set screw, thread locker, or some other common thread locking methodology. The configuration could be reversed, having the external threads on the wheel, and the internal threads on the protection device.

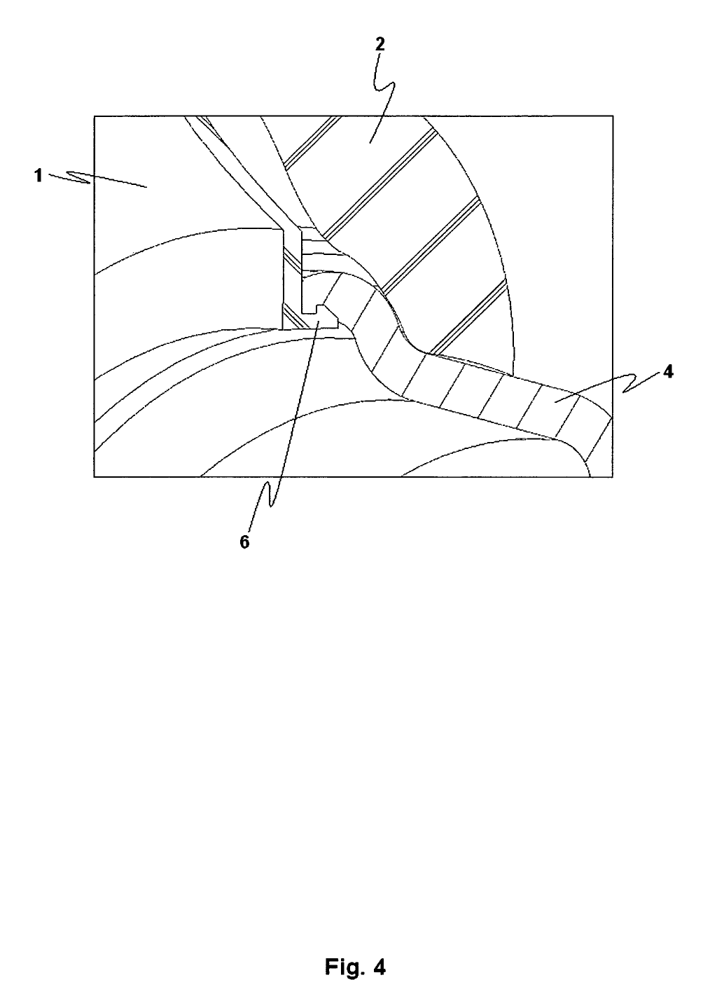

FIG. 4 illustrates the protection device 1 attached directly to the rim 4 using a clip interface 6. The protection device is constructed with a continuous or discrete series of clips that retain the protection device when assembled to the wheel/tire assembly. The clip can be an interference fit or snap fit onto the rim 4. As such, the clips can be internal to the rim 4 (as shown), external, or intermediate (directly into the flange 8).

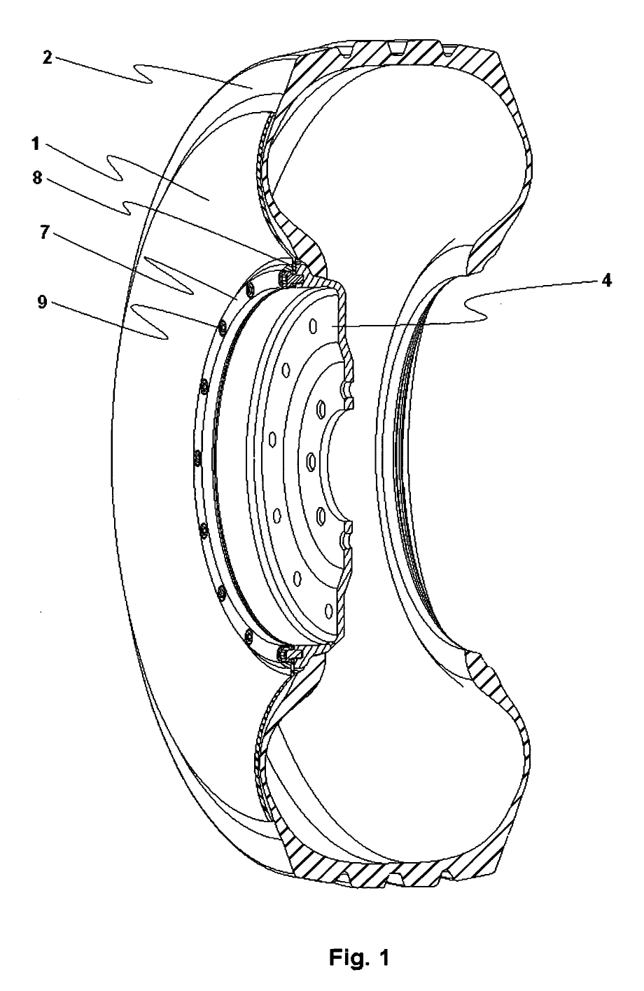

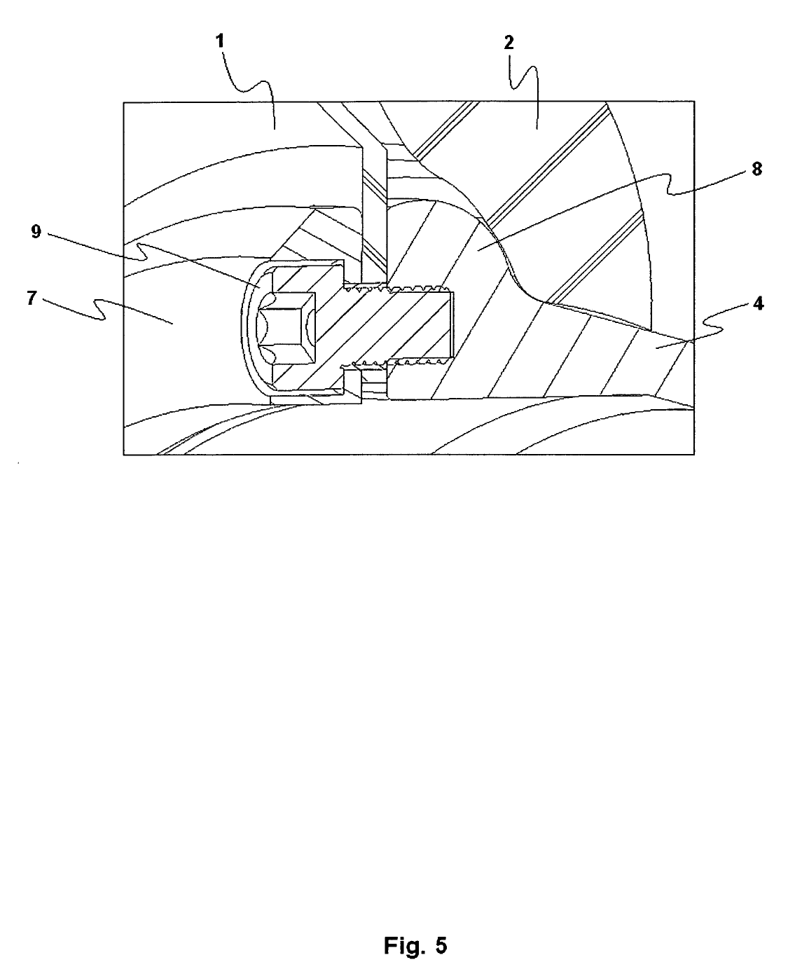

FIG. 1 illustrates the protection device 1 attached to the wheel/tire assembly by means of a clamping ring 7 on the rim flange 8. The protection device 1 is compressed between the rim flange 8 and the clamping ring 7. The clamping ring 7 can be affixed to the wheel using threaded fasteners 9, keyhole lock pins, locking tabs, rivets, or other means. FIG. 5 shows a detailed view of the clamping ring 7 attached to the wheel/tire assembly using a threaded fastener 9. Although a threaded fastener is shown, it is obvious that other connection methods, such as rivets, can be used.

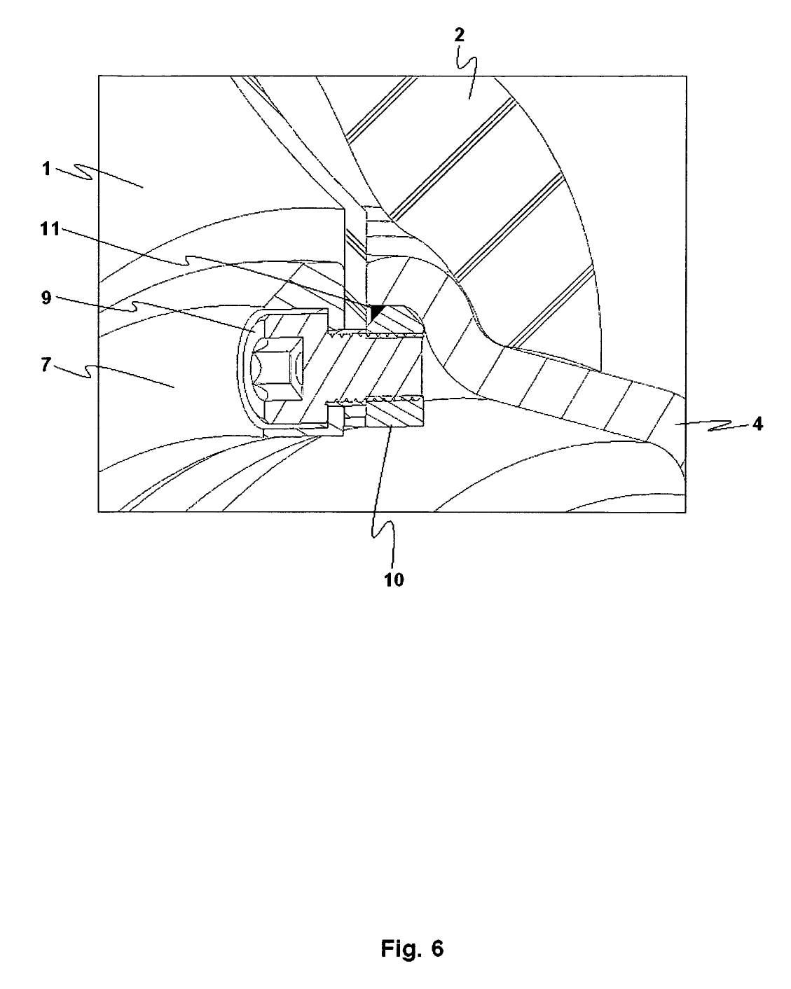

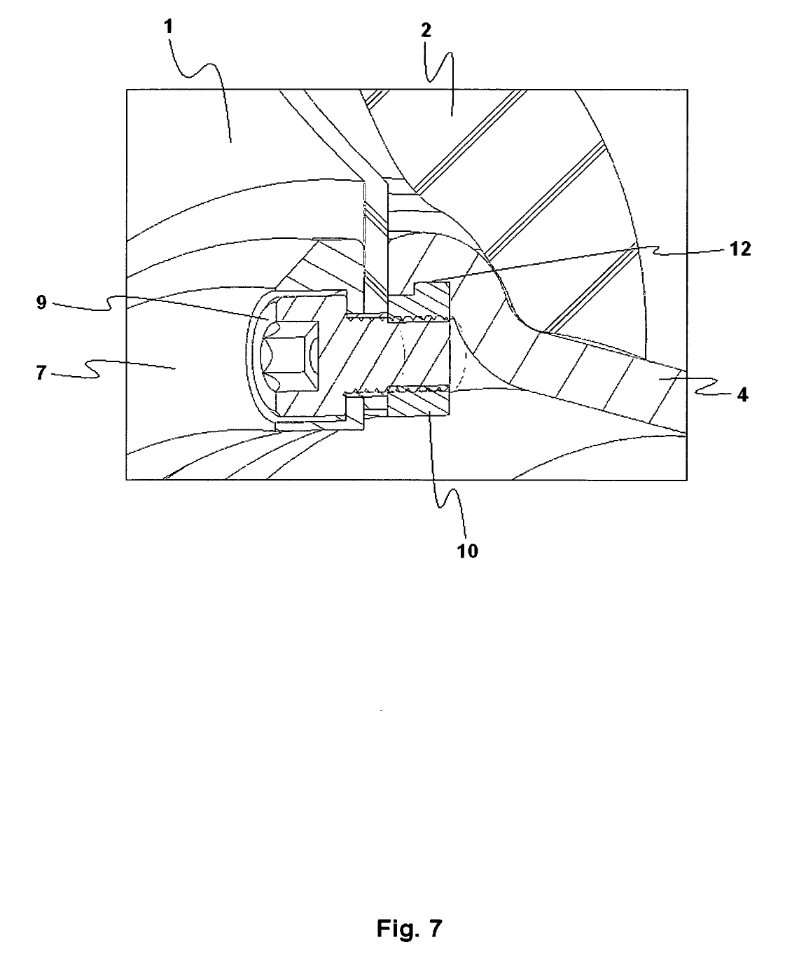

FIG. 6 illustrates the protection device 1 attached to the wheel/tire assembly by means of a clamping ring 7 on an intermediate body that is affixed to the wheel/tire assembly. This is to account for cases in which the rim is not suited for direct connection, as may be the case with a steel wheel that has a relatively thin section in the flange area 8. A supporting ring 10 or sectors may be added to the rim to allow the clamping ring 7 to affix to the wheel as described in Section 5(d). The ring 10 or sectors may be welded 11 or bonded to the wheel/tire assembly. FIG. 7 illustrates an alternative to welding or bonding a continuous supporting ring 10 to the wheel/tire assembly. A snap-fit or mechanical interference 12 can be used to affix the supporting ring 10 to the wheel/tire assembly.

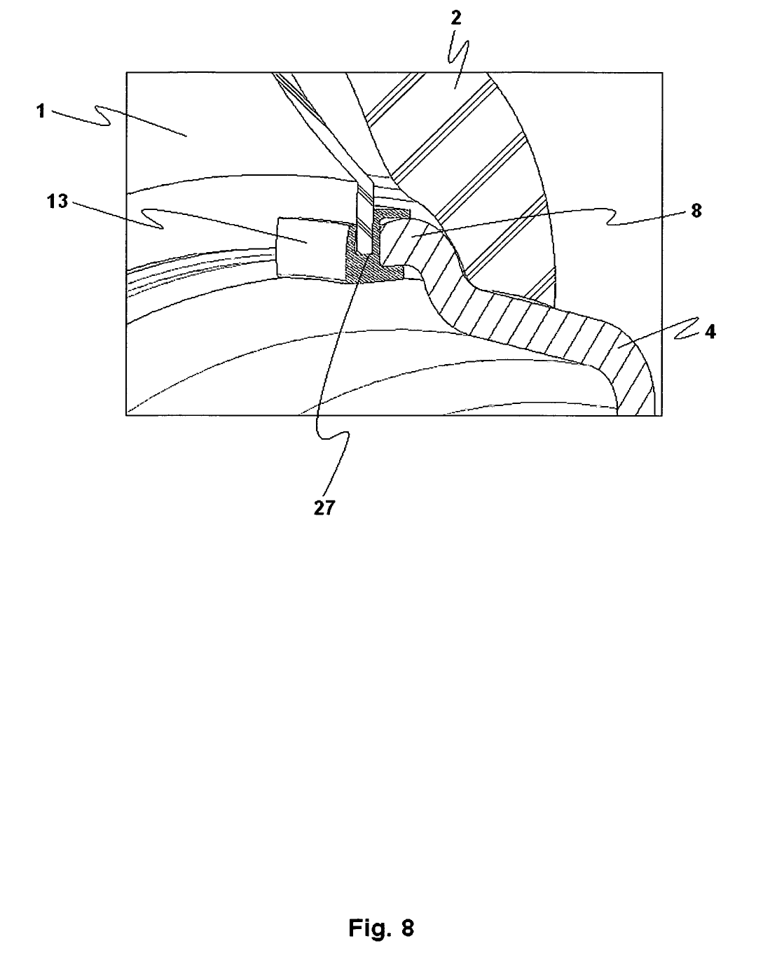

FIG. 8 illustrates the protection device 1 attached to the wheel/tire assembly by means of a series of clips 13. Each clip 13 features a slot 27 with which the protection device mates. The clips are constructed and mounted in such a fashion to keep the protection device in tension and/or allow the use of retaining hardware to keep the protection device firmly in place. The clip 13 is designed with a contour that allows it to grip to the rim flange 8, similar to crimp-on balance weights used on passenger cars. Additionally, the clip can be separate pieces or can be made as an integrated portion of the protection device 1.

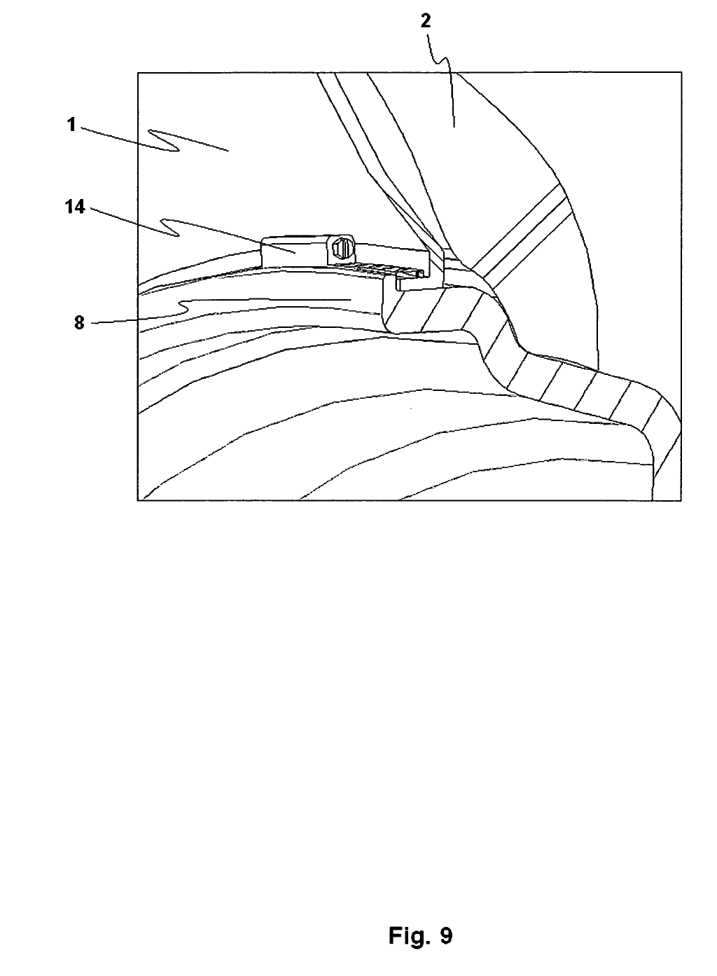

FIG. 9 illustrates the protection device 1 attached to the wheel/tire assembly by means of a circumferential clamping to the rim flange 8. The protection device 1 is constructed such that it can be clamped between the circumferential retaining device. A hose clamp 14 is an example of a circumferential retaining device that can clamp the protection device 1 radially inward to the rim flange 8. A rigid ring with a spanner is an example of a circumferential retaining device that can clamp the protection device 1 radially outward to a specially contoured rim flange 8 (not shown). Although a screw-type hose clamp is shown, any variety of well-known configurations of hose clamps can be used.

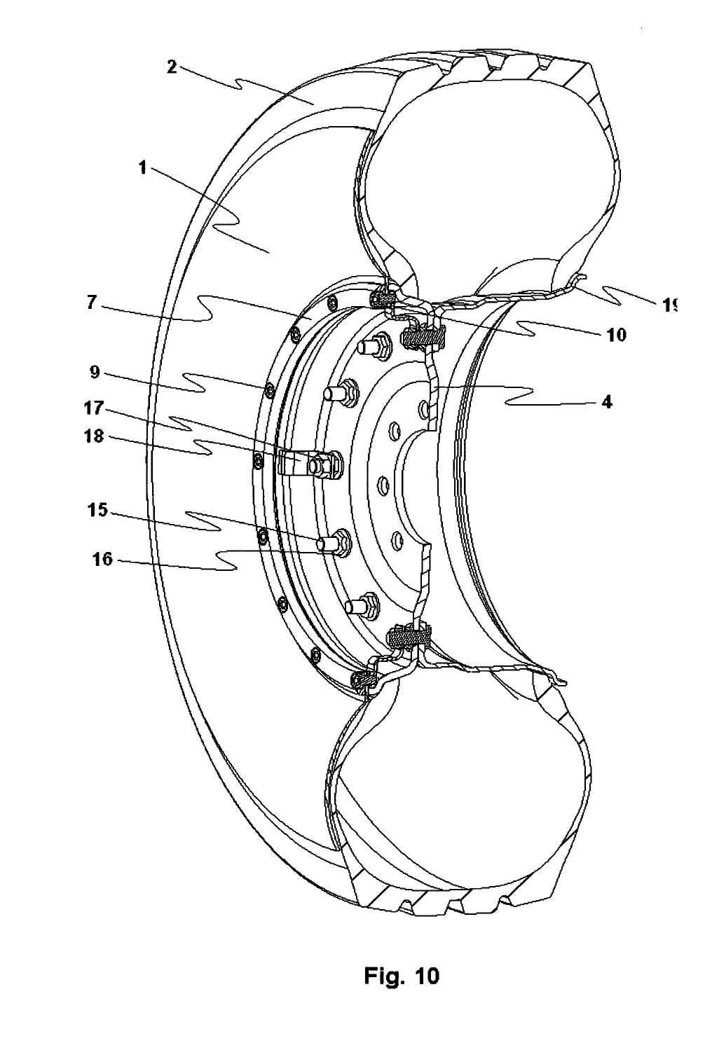

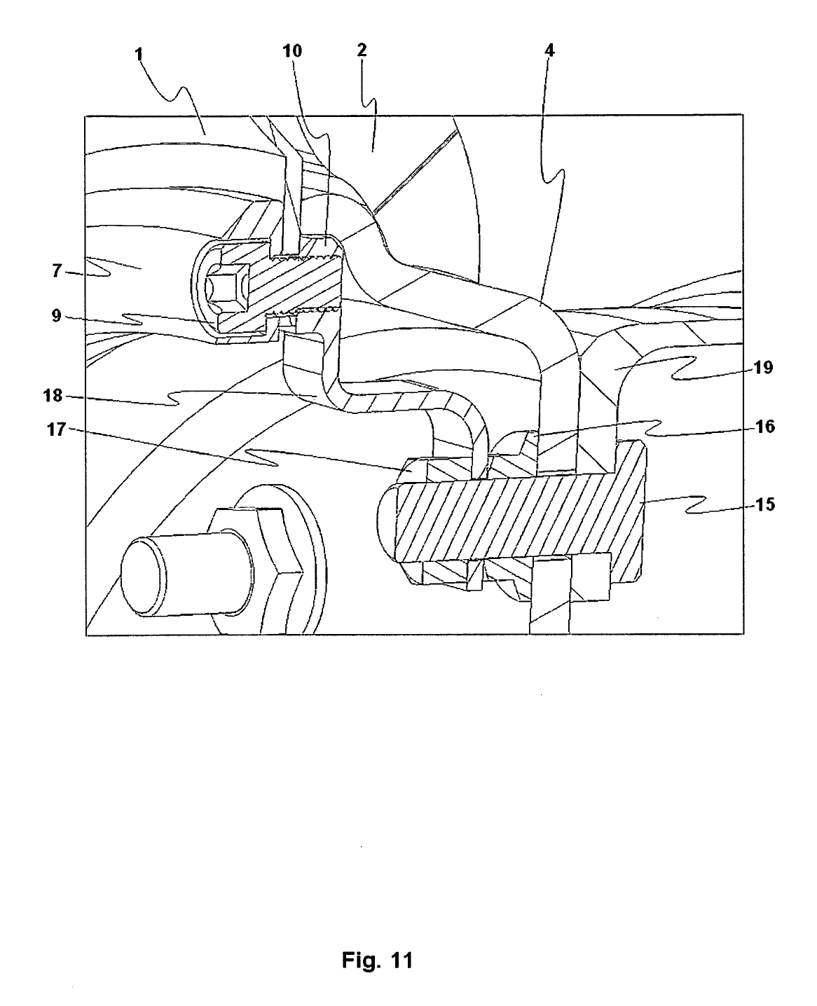

FIG. 10 illustrates the protection device 1 attached to the wheel/tire assembly using the stud 15 and/or nut 16 that fastens a multi-piece wheel together. The protection device 1 can be attached to the hardware using some type of mechanical fastener, shown herein with a jam nut 17. Alternatively, the protection device 1 can be attached without a mechanical fastener if it is clamped by the stud 15 or nut 16. Rubber grommets or similar devices can be used to dampen or mitigate vibrations, impacts, or other dynamic events that may occur on the wheel assembly. The protection device 1 may or may not use a bracket 18 or other type of standoff to attach the ring 10 to the wheel hardware. A close-up view of the connection is shown in FIG. 11.

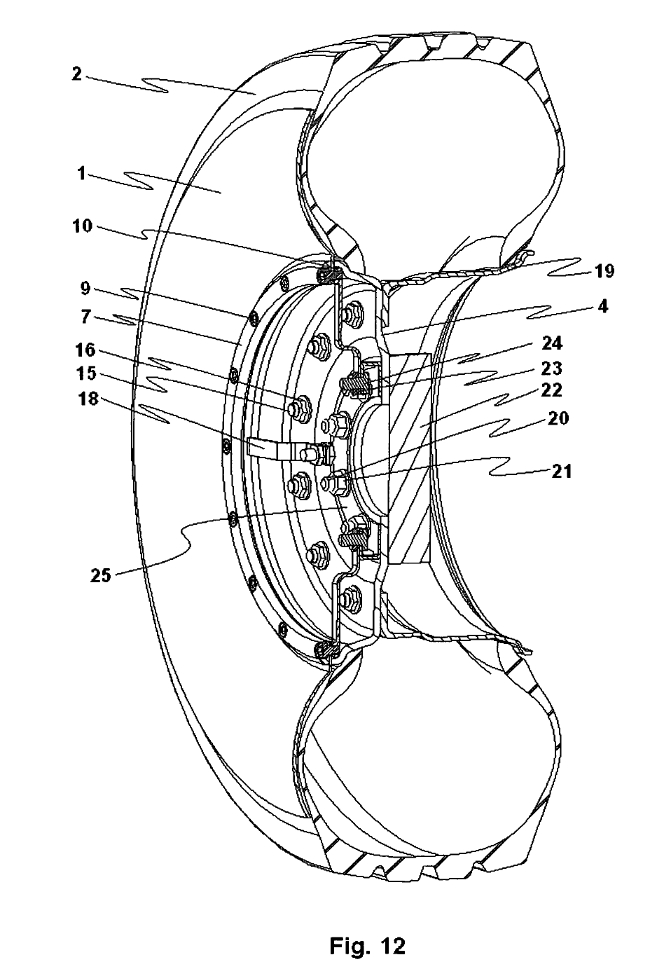

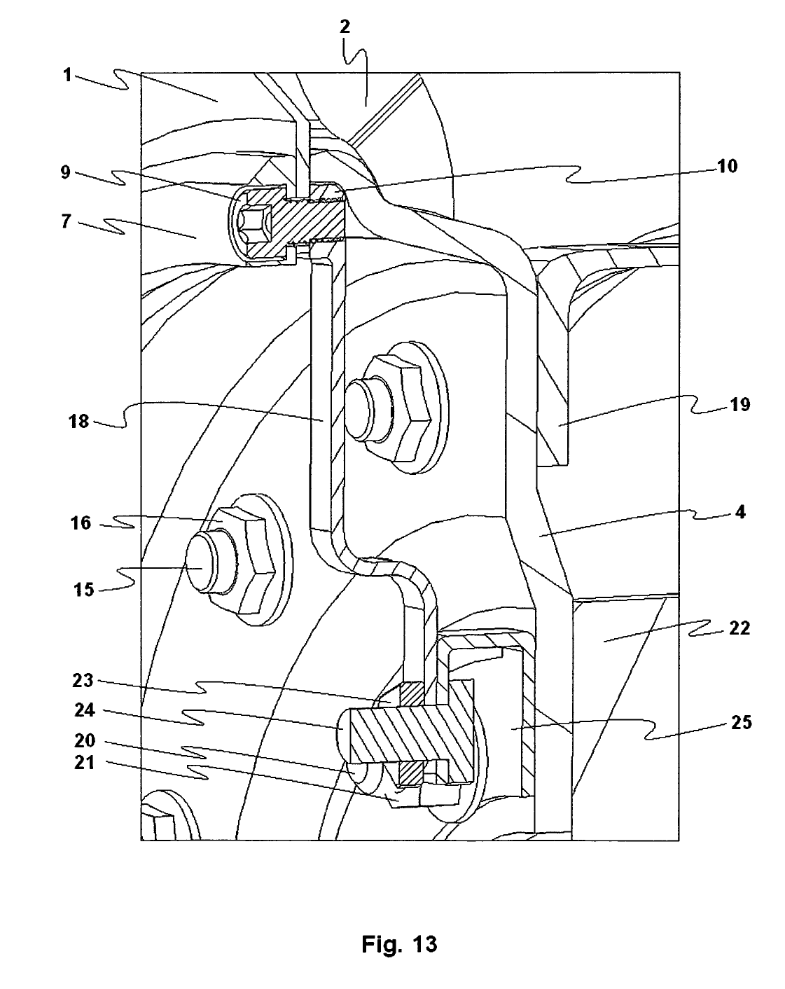

FIG. 12 illustrates the protection device 1 attached to the wheel/tire assembly in the disc area using the lug stud 20 and/or lug nut 21 that fastens the wheel assembly to the vehicle hub 22. The protection device 1 can be attached to the hardware using some type of mechanical fastener, shown herein with a bolted connection 23/24. As described in 5(h) the protection device 1 can be attached without a mechanical fastener if it is clamped by the lug stud 20 or lug nut 21. Rubber grommets or similar devices can be used to dampen or mitigate vibrations, impacts, or other dynamic events that may occur on the wheel assembly. The protection device 1 may or may not use a bracket 18 or other type of standoff 25 to attach to the wheel hardware. A close-up view of the connection is shown in FIG. 13.

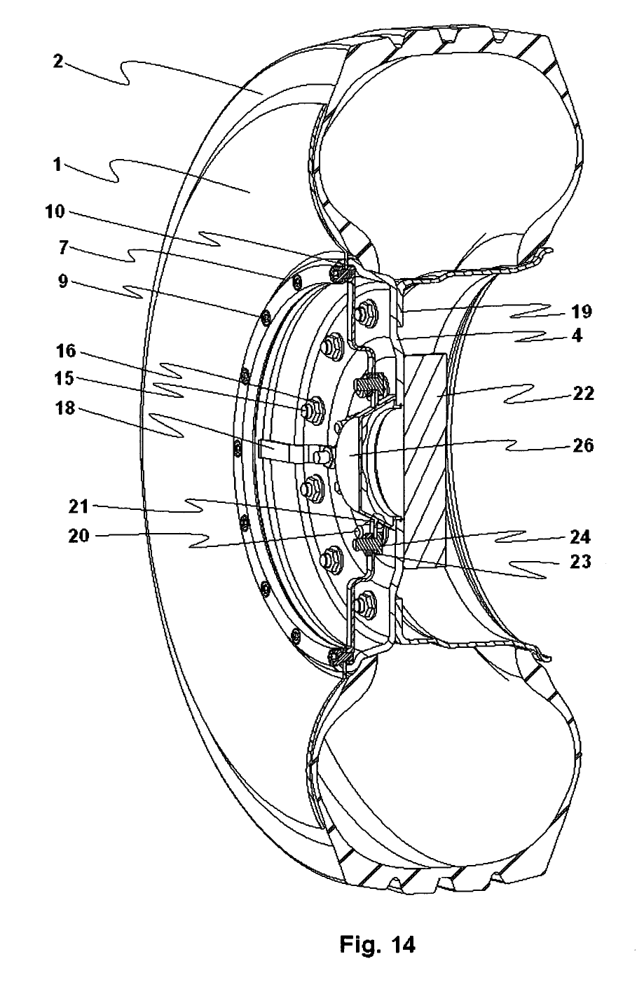

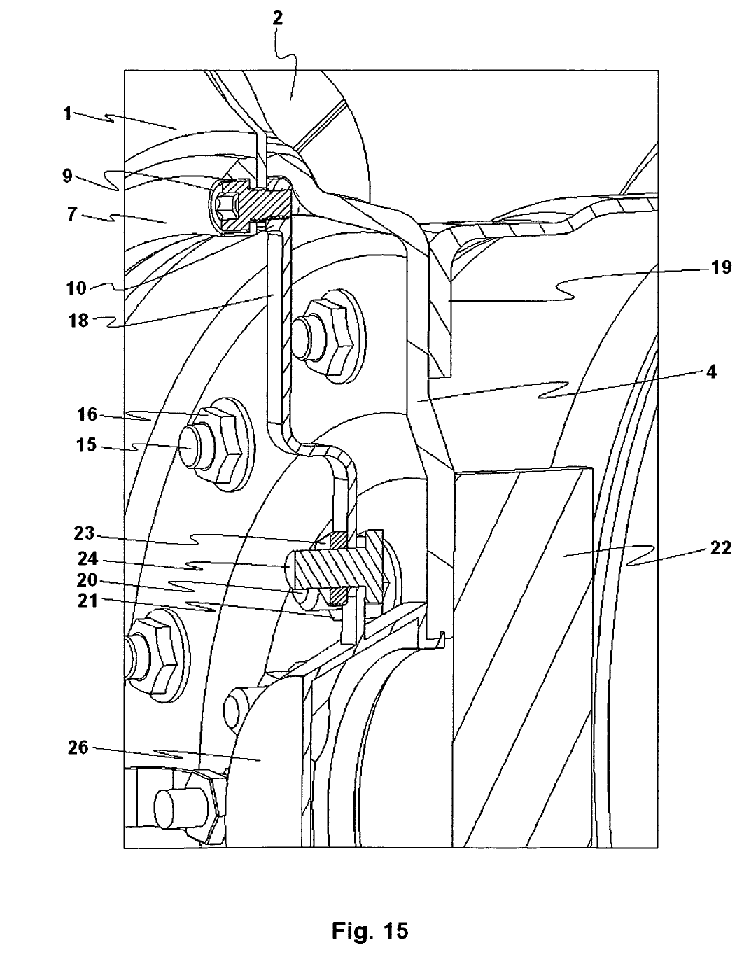

FIG. 14 illustrates the protection device 1 can be combined with the functionality of a wheel cover 26. Wheel covers can be attached to the wheel by any one or combination of methodologies, including but not limited to threaded fasteners, wire springs, attachment to assembly hardware, attachment to the lug hardware, or snap fit into the wheel, etc. (See, also, FIG. 15).

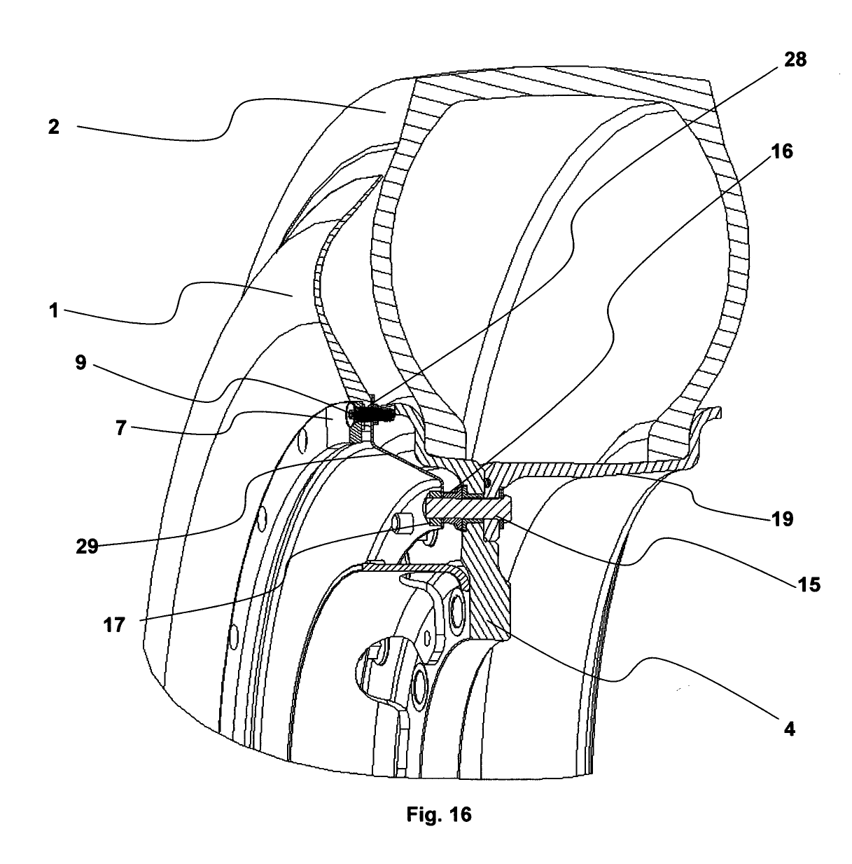

FIG. 16 illustrates the protection device 1 attached to the wheel/tire assembly using an adapter ring 29 between the protection device 1 and the stud 15 and nut 16 that fastens a multi-piece wheel together. The adapter ring 29 can be attached to the hardware using some type of mechanical fastener, shown herein with a jam nut 17. The protection device 1 is shown attached to the adapter ring 29 using a fastener 9, a clamp ring 7, and a nut 28, which may or may not be permanently affixed to the adapter ring 29.

The described advantages and features of the invention are advantageously provided through and using the preferred embodiments previously illustrated and discussed. However, numerous variations are possible without deviating from and/or exceeding the spirit and scope of the invention. For example, various rim sizes and profiles can be used. In addition, in terms of wheel materials, this invention can be utilized on wheels of any material or material combination including, but not limited to, aluminum, steel, titanium, composites, etc. Further, the application of this invention extends to use on both single-piece and multi-piece rims. Also, the invention can be implemented on either inboard or outboard or both rim flanges or wheel halves. Finally, various features and functions disclosed above, or alternatives thereof, may be desirably combined into many other different systems or applications. Moreover, various presently unforeseen or unanticipated alternatives, modifications, variations or improvements therein may be subsequently made by those skilled in the art which are also intended to be encompassed by the claims when filed.

Finally, the following parts list for the drawing figures may be found to be of assistance in understanding more fully the concepts of our invention:

1. Shield

2. Tire

3. Adhesive

4. Outer Rim

5. Threaded Interface

6. Clip Interface

7. Clamping Ring

8. Rim Flange

9. Fastener

10. Supporting Ring

11. Welded Interface

12. Snap-fit Interface

13. Clip-on Connector

14. Hose Clamp

15. Assembly Stud

16. Assembly Nut

17. Jam Nut

18. Bracket

19. Inner Rim

20. Lug Stud

21. Lug Nut

22. Vehicle Hub

23. Nut (bracket attachment to standoff)

24. Bolt (bracket attachment to standoff)

25. Standoff

26. Wheel Cover

27. Clip Slot

28. Nut

29. Adapter Ring

What is claimed is:

1. A tire protection attachment system, comprising:
apparatus for holding a covering of protective material adjacent a sidewall of a tubeless tire mounted on a circular wheel rim;
wherein said wheel rim has formed coaxially on opposite ends thereof outwardly flaring circumferential flange sections disposed to be engaged by beads of the tubeless tire mounted on the rim;
wherein said wheel rim has intermediate said opposite ends thereof a transverse wall section extending transversely of the axis of said rim, and having therethrough a central opening disposed coaxially of said axis; and
wherein said apparatus for holding said covering of protective material adjacent a sidewall comprises: adherent materials by which said covering of protective material adheres to and is held in place adjacent said sidewall, and mechanical attachments by which said covering of protective material is attached to the wheel rim and is held in place adjacent said sidewall.

2. The system described in claim 1, wherein said covering is adhered to the sidewall via one of: an adhesive material intermediate said sidewall and said covering, and adhering said covering directly to said sidewall.

3. The system described in claim 1, wherein said mechanical attachments are to one of the outwardly flaring circumferential flange section adjacent said sidewall, and said transverse wall section.

4. The system described in claim 3, wherein said attachments are to said outwardly flaring circumferential flange section and include one of:
a substantially circumferential clamping ring by which said covering of protective material is held in position adjacent the sidewall by clamping a portion of said covering between said clamping ring and one of said flange section, and an intermediate body affixed to said flange section;
at least one clip by which said covering of protective material is held in position adjacent the sidewall, said clip being attached to said covering and said flange section; and
a substantially circumferential retaining device by which said covering of protective material is held in position adjacent the sidewall, said retaining device having a circumference that can be varied to clamp a portion of said covering between said retaining device and a portion of said flange section.

5. The system described in claim 4, wherein one of:
said intermediate body is affixed to said flange section by one of: adhesive, welding, or interlocking sections,
said clamping ring is bolted directly onto said flange section, said flange section having at least one screw threaded hole by which a bolt, having passed through an aligned aperture in said clamping ring, can be bolted into said flange section so as to affix said clamping ring thereto,
the clamping ring is screwed onto said flange section, said flange section and said clamping ring having interfacing circumferentially arranged screw threaded portions, and
the clamping ring is snapped onto said flange section, said flange section and said clamping ring having interfacing circumferentially arranged interlocking portions.

6. The system described in claim 3, wherein said mechanical attachments made to said transverse wall section include attachments to a stud that is one of: a stud fastening a two piece wheel together and a lug stud.

7. The system described in claim 6, further including a substantially circumferential clamping ring by which said covering of protective material is held in position adjacent the sidewall by clamping a portion of said covering via said clamping ring.

8. The system of claim 3, further comprising a wheel cover held in position via mechanical attachments to one of the outwardly flaring circumferential flange section adjacent said sidewall, and said transverse wall section.

9. The system of claim 6, including one of: a circumferential adapter ring and a bracket intermediate and connecting said stud and said covering.

10. The system of claim 7, including one of: a circumferential adapter ring and a bracket intermediate and connecting said stud and said covering.

11. A tire protection attachment system, comprising:
apparatus for holding a covering of protective material adjacent a sidewall of a tubeless tire mounted on a circular wheel rim;
wherein said wheel rim has formed coaxially on opposite ends thereof outwardly flaring circumferential flange sections disposed to be engaged by beads of the tubeless tire mounted on the rim;
wherein said wheel rim has intermediate said opposite ends thereof a transverse wall section extending transversely of the axis of said rim, and having therethrough a central opening disposed coaxially of said axis;
wherein said apparatus for holding said covering of protective material adjacent a sidewall comprises mechanical attachments by which said covering of protective material is attached to the wheel rim and is held in place adjacent said sidewall; and
wherein said mechanical attachments are to one of the outwardly flaring circumferential flange section adjacent said sidewall, and said transverse wall section via a stud that is one of: a stud fastening a two piece wheel together, and a lug stud.

12. The system described in claim 11, wherein said attachments are to said outwardly flaring circumferential flange section and include one of:
a substantially circumferential clamping ring by which said covering of protective material is held in position adjacent the sidewall by clamping a portion of said covering via said clamping ring,
at least one clip by which said covering of protective material is held in position adjacent the sidewall, said clip being attached to said covering and said flange section, and
a substantially circumferential retaining device by which said covering of protective material is held in position adjacent the sidewall, said retaining device having a circumference that can be varied to clamp a portion of said covering between said retaining device and a portion of said flange section.

13. The system described in claim 12, wherein one of:
said intermediate body is affixed to said flange section by one of: adhesive, welding, or interlocking sections,
said clamping ring is bolted directly onto said flange section, said flange section having at least one screw threaded hole by which a bolt, having passed through an aligned aperture in said clamping ring, can be bolted into said flange section so as to affix said clamping ring thereto,
the clamping ring is screwed onto said flange section, said flange section and said clamping ring having interfacing circumferentially arranged screw threaded portions, and
the clamping ring is snapped onto said flange section, said flange section and said clamping ring having interfacing circumferentially arranged interlocking portions.

14. The system of claim 10, further comprising a wheel cover held in position via mechanical attachments to one of the outwardly flaring circumferential flange section adjacent said sidewall, and said transverse wall section.

15. The system of claim 10, including one of: a circumferential adapter ring and a bracket intermediate and connecting said stud and said covering.

16. The system of claim 15, including one of: a circumferential adapter ring and a bracket intermediate and connecting said stud and said covering.

17. The system of claim 1, wherein said mechanical attachments to not include elements located intermediate said beads and flange sections.

18. The system of claim 4, wherein said mechanical attachments to not include elements located intermediate said beads and flange sections.

19. The system of claim 11, wherein said mechanical attachments to not include elements located intermediate said beads and flange sections.

20. The system of claim 12, wherein said mechanical attachments to not include elements located intermediate said beads and flange sections.
